(19) United States
(12) Patent Application Publication
(10) Pub. No.: US 2026/0019553 A1
(43) Pub. Date: Jan. 15, 2026

(54) STEREOSCOPIC DISPLAY DEVICE AND STEREOSCOPIC DISPLAY METHOD

(71) Applicant: JVCKENWOOD Corporation, Kanagawa (JP)

(72) Inventor: Fumihiko ITO, Yokohama-shi (JP)

(21) Appl. No.: 19/335,952

(22) Filed: Sep. 22, 2025

Related U.S. Application Data
(63) Continuation of application No. PCT/JP2024/011380, filed on Mar. 22, 2024.

(30) Foreign Application Priority Data
Mar. 24, 2023 (JP) 2023-048666

(51) Int. Cl. H04N 13/32; H04N 13/322

(52) U.S. Cl. CPC H04N 13/32; H04N 13/322

(57) ABSTRACT

A stereoscopic display device includes a laser light source configured to emit a laser beam, a converter configured to convert the emitted laser beam to a collimated beam with a predetermined diameter, a divider configured to divide the collimated beam into a zeroth-order beam and a higher-order beam equal to or higher than a first-order beam by changing a wavefront of the collimated beam, a scanner configured to three-dimensionally scan a light condensing position of a converged beam by using a drawing space including a fluorescent material which is excited to spontaneously emit light with irradiation with a laser beam as a scan target range and changing optical axis directions in which converged beams including the zeroth-order beam and the higher-order beam are emitted and a focal distance at which the zeroth-order beam converges, and an intensity control unit configured to control an intensity at the light condensing position.

### TECHNICAL FIELD

The present invention relates to a stereoscopic display device and a stereoscopic display method.

Priority is claimed on Japanese Patent Application No. 2023-048666, filed Mar. 24, 2023, the content of which is incorporated herein by reference.

### BACKGROUND ART

In the related art, various methods for a stereoscopic display device that displays a video in the air have been proposed. For an example of the stereoscopic display device according to the related art, a technique of displaying a video in the air by forming voxels (spatial pixels) by condensing a laser beam to generate plasma has been disclosed (for example, see Patent Document 1).

### CITATION LIST

### Patent Document

Patent Document 1: Japanese Unexamined Patent Application, First Publication No. 2007-206588

### SUMMARY OF INVENTION

In the aforementioned stereoscopic display device, a stereoscopic image with sufficient brightness can be drawn by causing a laser beam to be incident as an excitation beam on a fluorescent material to generate bright spots. On the other hand, it may be difficult to draw a bright spot at a desired position according to a correlation between characteristics of a fluorescent material and an intensity of a laser beam which is an excitation beam. In this case, there is a problem in that image quality of a stereoscopic image will deteriorate.

The present invention was made in consideration of the aforementioned circumstances, and an objective thereof is to provide a stereoscopic display device and a stereoscopic display method that can improve image quality of a stereoscopic image.

[1] According to an aspect of the present invention, there is provided a stereoscopic display device including a laser light source configured to emit a laser beam, a converter configured to convert the emitted laser beam to a collimated beam with a predetermined diameter, a divider configured to divide the collimated beam into a zeroth-order beam and a higher-order beam equal to or higher than a first-order beam by changing a wavefront of the collimated beam, a scanner configured to three-dimensionally scan a light condensing position of a converged beam by using a drawing space including a fluorescent material which is excited to spontaneously emit light with irradiation with a laser beam as a scan target range and changing optical axis directions in which converged beams including the zeroth-order beam and the higher-order beam are emitted and a focal distance at which the zeroth-order beam converges, and an intensity control unit configured to control an intensity at the light condensing position on the basis of drawing data indicating a light emission intensity at each position in the drawing space.

[2] In the stereoscopic display device according to the aspect of [1] of the present invention, the divider is a spatial phase modulator and distributes a focal position of the zeroth-order beam and a focal position of the higher-order beam at positions apart in the optical axis directions at the light condensing position.

[3] In the stereoscopic display device according to the aspect of [1] of the present invention, the divider is a two-dimensional diffraction grating and distributes a focal position of the zeroth-order beam and a focal position of the higher-order beam at positions apart in diameter directions of the converged beams at the light condensing position.

[4] According to another aspect of the present invention, there is provided a stereoscopic display method including emitting a laser beam, converting the emitted laser beam to a collimated beam with a predetermined diameter, dividing the collimated beam into a zeroth-order beam and a higher-order beam equal to or higher than a first-order beam by changing a wavefront of the collimated beam, three-dimensionally scanning a light condensing position of a converged beam by using a drawing space including a fluorescent material which is excited to spontaneously emit light with irradiation with a laser beam as a scan target range and changing optical axis directions in which converged beams including the zeroth-order beam and the higher-order beam are emitted and a focal distance at which the zeroth-order beam converges, and controlling an intensity at the light condensing position on the basis of drawing data indicating a light emission intensity at each position in the drawing space.

According to the present invention, it is possible to control a state of a stereoscopic image according to an observation situation.

### BRIEF DESCRIPTION OF DRAWINGS

FIG. 1 A diagram illustrating an example of a configuration of a stereoscopic display device according to an embodiment.

FIG. 2 A diagram illustrating an example of a flow of operations that are performed by the stereoscopic display device according to the present embodiment.

FIG. 3 A diagram illustrating an example of a light condensing state at a light condensing position according to the present embodiment.

FIG. 4 A diagram illustrating an example of a model of calculating incident energy of a converged beam at a light condensing position according to the embodiment.

FIG. 5 A diagram illustrating an example of a light emission intensity of a fluorescent material when a divider is not provided.

FIG. 6 A diagram illustrating an example of an optical path of a converged beam when a divider according to a first embodiment is used.

FIG. 7 A diagram illustrating an example of an optical path in an enlarged view of a light condensing position according to the embodiment.

FIG. 8A A diagram illustrating an example of a cross-section of a converged beam at a light condensing position according to the embodiment.

FIG. 8B A diagram illustrating an example of a cross-section of a converged beam at a light condensing position according to the embodiment.

FIG. 8C A diagram illustrating an example of a cross-section of a converged beam at a light condensing position according to the embodiment.

FIG. 9 A diagram illustrating an example of a light emission intensity of a fluorescent material according to the embodiment.

FIG. 10 A diagram illustrating an example of an optical path in an enlarged view of a light condensing position when optimization is performed with another concentration according to the embodiment.

FIG. 11A A diagram illustrating an example of a cross-section of a converged beam at a light condensing position when optimization is performed with another concentration according to the embodiment.

FIG. 11B A diagram illustrating an example of a cross-section of a converged beam at a light condensing position when optimization is performed with another concentration according to the embodiment.

FIG. 11C A diagram illustrating an example of a cross-section of a converged beam at a light condensing position when optimization is performed with another concentration according to the embodiment.

FIG. 12 A diagram illustrating an example of a light emission intensity of a fluorescent material according to the embodiment.

FIG. 13 A diagram illustrating an example of an optical path of a converged beam when a divider according to a second embodiment is used.

FIG. 14 A diagram illustrating an example of an optical path in an enlarged view of a light condensing position according to the embodiment.

FIG. 15 A diagram illustrating an example of a cross-section of a converged beam at a light condensing position according to the embodiment.

FIG. 16 A diagram illustrating another example of an optical path in an enlarged view of a light condensing position according to the embodiment.

FIG. 17 A diagram illustrating another example of a cross-section of a converged beam at a light condensing position according to the embodiment.

FIG. 18 A diagram illustrating an example of a light emission intensity of a fluorescent material according to the embodiment.

FIG. 19 A diagram illustrating an example of a light emission intensity of a fluorescent material according to the embodiment.

FIG. 20 A diagram illustrating an example of an optical path near the light condensing position according to a modified example of the embodiment.

FIG. 21A A diagram illustrating an example of a cross-section of a converged beam according to a modified example of the embodiment.

FIG. 21B A diagram illustrating an example of a cross-section of a converged beam according to a modified example of the embodiment.

FIG. 21C A diagram illustrating an example of a cross-section of a converged beam according to a modified example of the embodiment.

### DESCRIPTION OF EMBODIMENTS

Exemplary embodiments of a stereoscopic display device according to an aspect of the present invention will be mentioned and described in detail below with reference to the accompanying drawings. The following embodiments are only examples, and an embodiment to which the present invention is applied is not limited to the embodiments. “On the basis of XX” mentioned in this specification means “on the basis of at least XX” and includes “on the basis of another element in addition to XX.” “On the basis of XX” is not limited to direct use of XX and includes use of results obtained by performing calculation or processing on XX. “XX” is an arbitrary factor (for example, arbitrary information). In the drawings used for the following description, sizes, numbers, and the like of constituent members may be made to be different from actual scales, numbers, and the like of the constituent members in order to make the constituent members be easily recognized.

Hereinafter, embodiments will be described with reference to the drawings.

### Functional Configuration of Stereoscopic Display Device 1

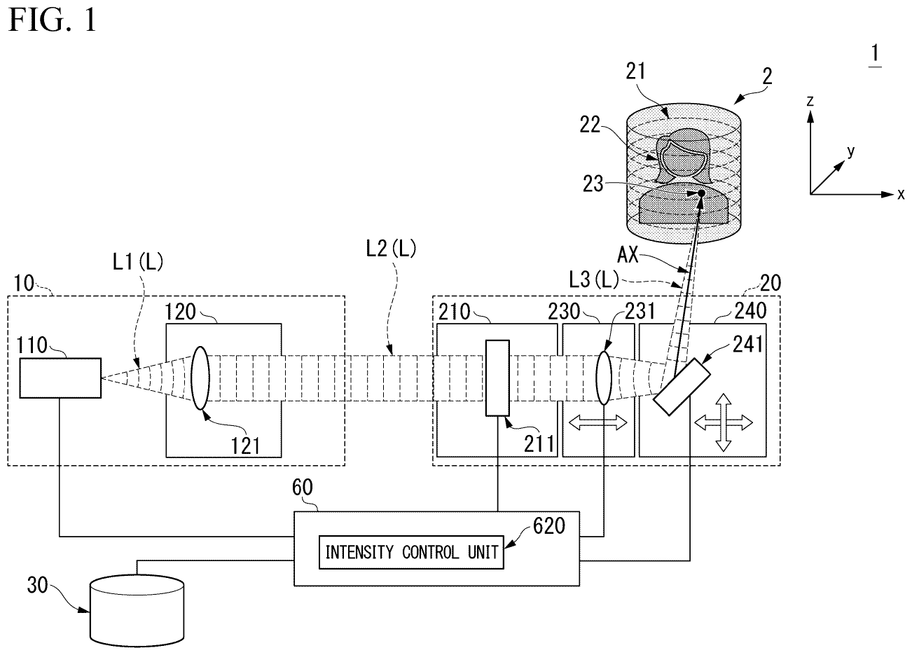

FIG. 1 is a diagram illustrating an example of a configuration of a stereoscopic display device 1 according to an embodiment. The stereoscopic display device 1 is a device that displays a stereoscopic image in a drawing space 2 by scanning the drawing space 2 which is a scan target range including a fluorescent material 21 with a laser beam L.

The drawing space 2 is a space in which the fluorescent material 21 can be maintained. For example, the drawing space 2 is an internal space of a cylindrical container with a cylindrical transparent wall in which a powder fluorescent material 21 is enclosed. In this case, the drawing space 2 is a hollow region. For example, the drawing space 2 is an object formed of a transparent resin into which the fluorescent material 21 is kneaded. In this case, the drawing space 2 is a solid region.

That is, “space” of the drawing space 2 has only to be a region which spreads three-dimensionally regardless of whether it is solid or not. The drawing space 2 may be formed of one of gas, liquid, and solid.

The fluorescent material 21 is a material having a photoluminescence effect and is a quantum dot (QD) dispersed material in an example of the present embodiment. The QD dispersed material is a material in which quantum dots are dispersed in an organic solvent (for example, toluene), a gas, or a solid at a predetermined volume concentration.

For example, the fluorescent material 21 may be formed by dispersing (scattering) a fluorescent substance including rare-earth element in a transparent resin and solidifying the resultant material.

The stereoscopic display device 1 includes a light source unit 10, an irradiation unit 20, a storage unit 30, and a control unit 60.

The light source unit 10 includes a laser light source 110 and a converter 120. The laser light source 110 emits a laser beam L. The laser light source 110 may be, for example, an ultraviolet laser or a small laser diode with a wavelength of 405 nm. In the following description, the laser beam L emitted from the laser light source 110 is also referred to as a source beam L1.

The source beam L1 emitted from the laser light source 110 is not a parallel beam and has characteristics in which the source beam spreads in a conical shape with the laser light source 110 as a vertex.

The source beam L1 immediately after it has been emitted from the laser light source 110 has a sufficiently small diameter. On the other hand, the source beam L1 at a position apart from the laser light source 110 has a larger diameter than that of the source beam L1 immediately after it has been emitted from the laser light source 110. Accordingly, the source beam L1 immediately after it has been emitted from the laser light source 110 has higher energy per unit area in the diameter direction. The source beam L1 at a position apart from the laser light source 110 has lower energy per unit area in the diameter direction (that is, a sectional area of a light flux).

The converter 120 includes a collimating lens 121. The collimating lens 121 converts the source beam L1 propagating in a conical shape to a parallel beam with a predetermined diameter. In the following description, the laser beam L converted to a parallel beam by the collimating lens 121 is also referred to as a collimated beam L2. That is, the converter 120 converts the emitted source beam L1 to a collimated beam L2 with a predetermined diameter.

The collimated beam L2 is a beam obtained by converting a source beam L1 with lower energy per unit area in the diameter direction to a parallel beam as described above. Accordingly, the collimated beam L2 has lower energy per unit area in the diameter direction.

The irradiation unit 20 causes the collimated beam L2 incident from the light source unit 10 to converge and guides the converged collimated beam L2 to a light condensing position 23 in the drawing space 2. In the following description, the collimated beam L2 caused to converge by the irradiation unit 20 is also referred to as a converged beam L3. A propagating direction of the converged beam L3 emitted from the irradiation unit 20 is also referred to as an optical axis AX.

As described above, the converged beam L3 is a beam obtained by causing the collimated beam L2 to converge (that is, to decrease in diameter). Accordingly, the converged beam L3 is higher in energy per unit area in the diameter direction than the collimated beam L2. The energy per unit area in the diameter direction of the converged beam L3 is the highest at a most converged (diameter-decreased) position.

That is, the energy of the converged beam L3 incident on the fluorescent material 21 is the highest at a most converged (diameter-decreased) position.

The irradiation unit 20 includes a divider 210, a converger 230, and a scanner 240.

The divider 210 includes a spatial phase modulator 211 or a diffraction grating 212 (a two-dimensional diffraction grating) and divides the collimated beam L2 into a zeroth-order beam and a higher-order beam by changing a wavefront of the collimated beam L2. In the following description, the zeroth-order beam in the collimated beam L2 divided by the divider 210 is also referred to as a zeroth-order collimated beam L210. The ±first-order beams in the collimated beam L2 divided by the divider 210 are also referred to as a +first-order collimated beam L211 and a −first-order collimated beam L212.

That is, the divider 210 divides the collimated beam L2 into a zeroth-order collimated beam L210 (a zeroth-order beam) and higher-order beams equal to or higher than a first-order beam (for example, a +first-order collimated beam L211 and a −first-order collimated beam L212) by changing a wavefront of the collimated beam L2.

The converger 230 includes a converging lens 231. The converging lens 231 can change a position on which the transmitted laser beam L converges (that is, a focal distance) under the control of the control unit 60. The laser beam L transmitted by the converger 230 includes the zeroth-order beam and the higher-order beam divided by the divider 210.

The scanner 240 includes a scan mirror 241 (for example, a galvano mirror or a polygon mirror) and changes an irradiation direction of the laser beam L caused to converge by the converger 230.

Here, a direction in which the scanner 240 scans the drawing space 2 will be described using a XYZ three-dimensional orthogonal coordinate system.

The X axis and the Y axis of the three-dimensional orthogonal coordinate system represent angles of view when the drawing space 2 is seen from the irradiation unit 20. The X axis represents a horizontal direction (a left-right direction in FIG. 1) of the drawing space 2. The Y axis represents a depth direction (a depth direction in FIG. 1) of the drawing space 2. The scanner 240 can emit the converged beam L3 to an arbitrary position in the XY plane of the drawing space 2 by changing the direction of the scan mirror 241. That is, the scanner 240 can be said to be a two-dimensional scanner that two-dimensionally scans the XY plane with the converged beam L3.

The Z axis of the three-dimensional orthogonal coordinate system represents a depth when the drawing space 2 is seen from the irradiation unit 20. The converger 230 can change the light condensing position 23 of the converged beam L3 in the Z-axis direction by changing a converging position of the converged beam L3 (a focal distance of the converging lens 231). That is, the converger 230 and the scanner 240 can also be said to be a three-dimensional scanner that three-dimensionally scans the XYZ space with the converged beam L3. In the following description, a three-dimensional scanner including the converger 230 and the scanner 240 are also simply referred to as a scanner.

In an example of the present embodiment, the drawing space 2 has a cylindrical shape. The scanner 240 causes the converged beam L3 to be incident on the drawing space 2 from a bottom surface of the cylindrical shape of the drawing space 2. In this example, the XY plane represents a plane parallel to the bottom surface of the drawing space 2. The Z axis represents the height of the cylindrical shape of the drawing space 2.

The scanner 240 three-dimensionally scans the light condensing position 23 of the laser beam L by using the drawing space 2 including the fluorescent material 21 which is excited to spontaneously emit light with irradiation with a laser beam L as a scan target range and changing the focal distance at which the converged beam L3 converges and a direction of the optical axis AX in which the converged beam L3 is emitted.

As described above, the laser beam L (that is, the converged beam L3) emitted from the scanner 240 includes the zeroth-order beam and the higher-order beam divided by the divider 210.

That is, the scanner 240 three-dimensionally scans the light condensing position 23 of the converged beam L3 by using the drawing space 2 including the fluorescent material 21 which is excited to spontaneously emit light with irradiation with a laser beam L as a scan target range and changing the direction of the optical axis AX (that is, optical axis directions) in which the converged beam L3 (the laser beam L) including a zeroth-order collimated beam L310 (the zeroth-order beam) and the higher-order beams (for example, a +first-order collimated beam L211 and a −first-order collimated beam L212) are emitted and the focal distance at which the zeroth-order collimated beam L310 (the zeroth-order beam) converges together.

In the present embodiment, the scanner 240 may include a light intensity adjuster (for example, an iris) for adjusting an emitted light intensity of the laser beam L (the collimated beam L2 or the converged beam L3) or a cutoff element (for example, a shutter) for cutting off emission of the laser beam L (both of which are not illustrated). The light intensity adjuster or the cutoff element are controlled in synchronization with the converger 230 and the scanner 240, and thus the light condensing position 23 of the converged beam L3 is controlled to be at an arbitrary position in the drawing space 2.

The converged beam L3 is used as an excitation beam for exciting the fluorescent material 21 at the light condensing position 23 in the drawing space 2. A light emission intensity of the fluorescent material 21 is proportional to the intensity of the excitation beam (that is, the intensity of the converged beam L3 converging on the light condensing position 23). The converged beam L3 converges on the light condensing position 23 and thus increases in energy per unit volume (that is, a volume energy density). Accordingly, the fluorescent material 21 strongly emits light at the light condensing position 23.

In the following description, a position on which the converged beam L3 converges most in the light condensing position 23 is also referred to as a condensing point.

The irradiation unit 20 draws a stereoscopic image 22 in the drawing space 2 by scanning the positions in the drawing space 2 as the light condensing position 23 using the converger 230 and the scanner 240 (that is, the three-dimensional scanner).

The irradiation unit 20 may perform scanning based on s-called vector scan or scanning based on so-called raster scan in the drawing space 2.

The storage unit 30 has a known storage function, for example, a semiconductor storage device or a magnetic storage device and stores various types of information used by the control unit 60.

The control unit 60 is, for example, a computer device and provides a predetermined function on the basis of programs and data stored in the storage unit 30. The control unit 60 includes an intensity control unit 620 as a functional unit thereof.

The intensity control unit 620 controls the intensity of the laser beam L emitted from the irradiation unit 20 on the basis of drawing data stored in the storage unit 30. Drawing data is information indicating brightness of an image at each three-dimensional position in the drawing space 2. That is, the drawing data is information for displaying a stereoscopic image 22.

That is, the intensity control unit 620 controls the intensity at the light condensing position 23 of the converged beam L3 (the laser beam L) which is scanned by the scanner 240 on the basis of the drawing data indicating a light emission intensity at each position in the drawing space 2.

### Operations of Stereoscopic Display Device 1

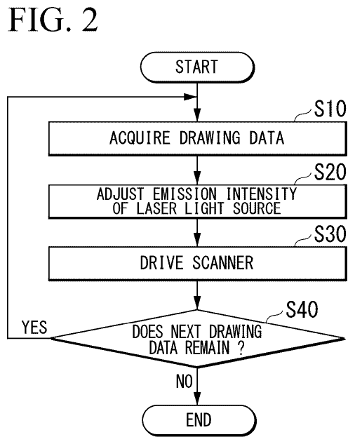

An example of a flow of operations of the stereoscopic display device 1 will be described below with reference to FIG. 2.

FIG. 2 is a diagram illustrating an example of a flow of operations of the stereoscopic display device 1 according to the present embodiment.

(Step S10) The control unit 60 acquires drawing data from the storage unit 30. As described above, the drawing data is information for displaying a stereoscopic image 22.

(Step S20) The control unit 60 controls an irradiation intensity of a laser beam L by controlling the laser light source 110.

(Step S30) The control unit 60 controls the light condensing position 23 of the converged beam L3 by controlling the converging lens 231 of the converger 230 and the scan mirror 241 of the scanner 240 (that is, by driving the scanner).

(Step S40) When scanning of three-dimensional positions indicated by the drawing data ends, the control unit 60 determines whether next drawing data remains. When it is determined that next drawing data remains (Step S40: YES), the control unit 60 returns the flow of operations to Step S10 and continues to perform the flow of operations. When it is determined that next drawing data does not remain (Step S40: NO), the control unit 60 ends the flow of operations.

### Relationship Between Intensity of Excitation Beam (Laser Beam L) and Light Emission State of Fluorescent Material

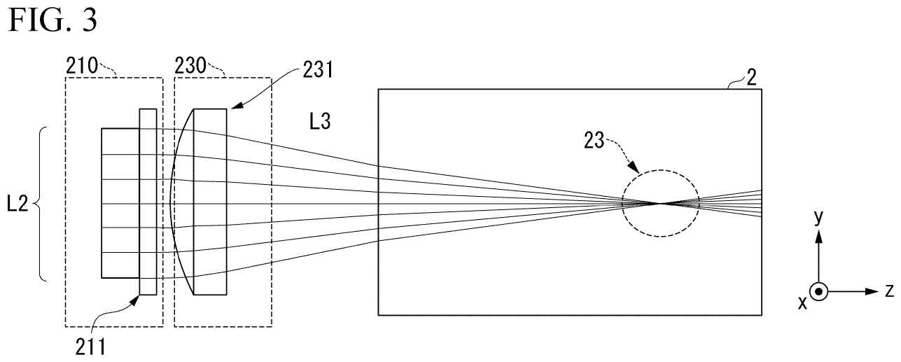

An example of a light condensing state at the light condensing position 23 according to the present embodiment will be described with reference to FIG. 3. The drawing does not illustrate the laser light source 110, the converter 120, and the scanner 240 and schematically illustrates a geometrical relationship of an optical path between the divider 210 and the converger 230 and the light condensing position 23.

The collimated beam L2 is incident on the divider 210. The divider 210 divides the collimated beam L2 into a zeroth-order beam and a higher-order beam.

The converger 230 includes the converging lens 231 and causes the collimated beam L2 divided into the zeroth-order beam and the higher-order beam to converge into a converged beam L3. The converger 230 condenses the converged beam L3 on the light condensing position 23 in the drawing space 2.

In the example illustrated in the drawing, simulation results based on the following conditions when the divider 210 includes a diffraction lens which is a diffraction member used instead of the spatial phase modulator 211 or the diffraction grating 212 and the converger 230 includes the converging lens 231 are illustrated.

### <Irradiation Unit 20>

Beam diameter of collimated beam L2: ϕ 12 mm to 20 mm
Condensing-point distance (distance between incidence position of drawing space 2 and light condensing position 23): 30 mm
Aperture number (NA): 0.2
Spot size at light condensing position 23 of converged beam L3: ϕ5 μm to 15 μm
Incident light intensity: 1.3 mW
Quantum efficiency: 80%

### <Divider 210 (Diffraction Lens)>

Material: BK7 (borosilicate crown glass)
Thickness (length in direction of optical axis (Z axis)): 2 mm
Shape: two planar sides including diffraction structure on rear surface
Second-order coefficient: 25.236
Air gap: thickness 2 mm

### <Converging Lens 231 (Condensing Lens)>

Material: BK7 (borosilicate crown glass)
Thickness (length in direction of optical axis (Z axis)): 7.24 mm
Shape: front surface: R25.84 mm, aspherical coefficient fourth-order 2.38×10E-6, sixth-order 1.33×10E-9, rear surface: planar
Air gap: thickness 20 mm

### <Drawing Space 2>

Refractive index of fluorescent material 21: 1.50
Thickness (length in direction of optical axis (Z axis)): 50 mm

As illustrated in the drawing, the collimated beam L2 which is a parallel beam converges at the light condensing position 23 in the drawing space 2 via the divider 210 and the converger 230.

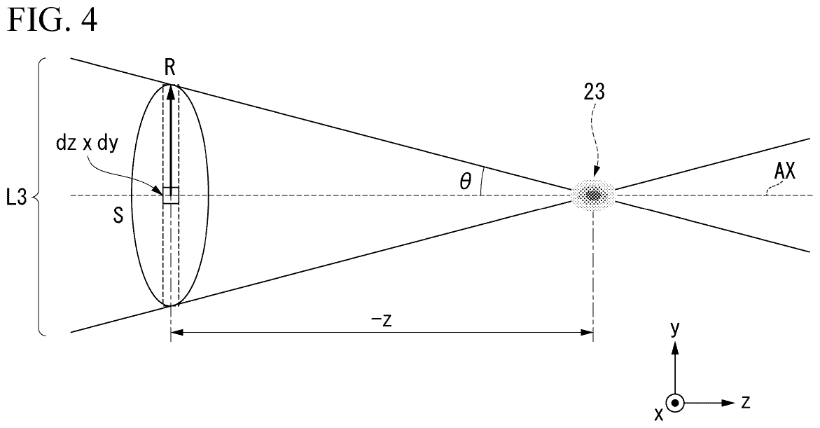

A model of calculating incident energy of the converged beam L3 at the light condensing position 23 will be described below with reference to FIG. 4.

FIG. 4 is a diagram illustrating an example of a model of calculating incident energy of a converged beam L3 at the light condensing position 23 according to the present embodiment. The converged beam L3 emitted from the irradiation unit 20 has a conical shape with the optical axis AX as the center and with the condensing point of the light condensing position 23 as a vertex. In the drawing, the direction of the optical axis AX matches the Z-axis direction. An angle θ is a half of a vertical angle of a cone (that is, an angle formed by the optical axis AX and a generating line of the cone). An area S is an area of a virtual disc (a cross-section of a cone) which is perpendicular to the optical axis AX and which has a radius R at a position apart by a distance z in the −Z direction (that is, toward the irradiation unit 20) from the condensing point of the light condensing position 23. A length dz is a thickness of the virtual disc (a minute length in the Z-axis direction).

The area S of the virtual disc can be expressed as a function with the distance z from the condensing point and the angle θ and becomes smaller as it becomes closer to the condensing point.

Accordingly, when the fluorescent material 21 is uniformly distributed in the drawing space 2, the number of particles of the fluorescent material 21 included in a volume (S×dz) of the virtual disc becomes smaller as it becomes closer to the condensing point. That is, the number of particles of the fluorescent material 21 included in the volume (S×dz) of the virtual disc becomes larger as it goes apart in the Z-axis direction from the condensing point with the condensing point as a minimum value.

The converged beam L3 incident on the drawing space 2 propagates while causing the fluorescent material 21 on the optical path in the drawing space 2 to emit light. Accordingly, the converged beam L3 decreases in energy by the number of particles of the fluorescent material 21×quantum efficiency according to a distance into the fluorescent material 21.

An energy density for each cross-section is calculated by dividing incidence energy of the converged beam L3 on the virtual disc by an area S of the virtual disc. This energy density increases rapidly in the vicinity of the condensing point of the light condensing position 23 at which the area S is relatively small.

The light emission intensity of the fluorescent material 21 is proportional to the energy density of the excitation beam (that is, the converged beam L3). Accordingly, the light emission intensity of the fluorescent material 21 increases rapidly in the vicinity of the condensing point of the light condensing position 23.

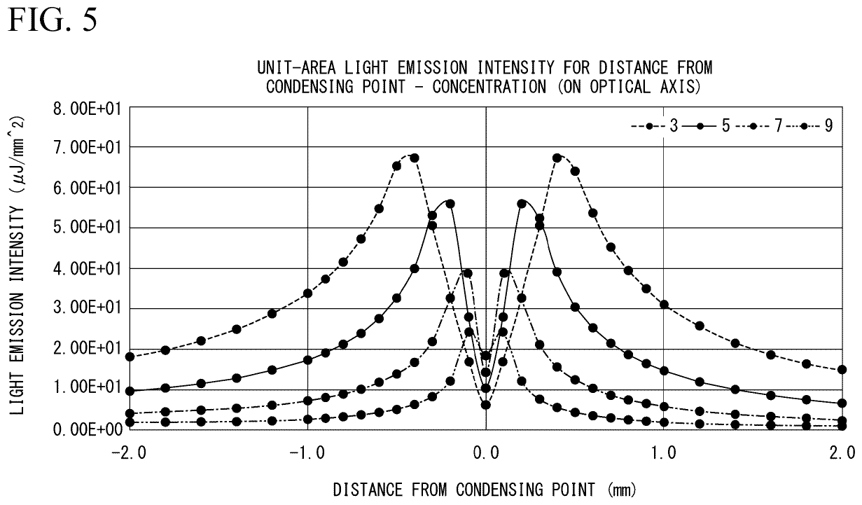

FIG. 5 is a diagram illustrating an example of a light emission intensity of the fluorescent material 21 when the divider 210 is not provided. The horizontal axis in the drawing represents a distance in the Z-axis direction from the condensing point, and the vertical axis represents a light emission intensity of the fluorescent material 21. The drawing illustrates characteristics of change in light emission intensity per unit area based on the number of particles of the fluorescent material 21 included in a minute volume (dz×dy×R in FIG. 4) of the virtual disc on the optical axis AX for each concentration of the fluorescent material 21.

In the drawing, it is seen that the light emission intensity becomes larger as it goes close to the condensing point from a position (for example, the distance±2.0 mm) apart in the Z-axis direction (the direction of the optical ax AX) from the condensing point (a distance 0.0 mm). On the other hand, it is also seen that an increase in light emission intensity reaches a limit point in the vicinity of the condensing point (for example, in the vicinity of the distance±0.5 mm). It is also seen that the light emission intensity decreases rapidly in a range closer to the condensing point (for example, equal to or less than the distance±0.4 mm).

In this way, when the light emission intensity of the fluorescent material 21 in the vicinity of the condensing point reaches a limit point, it means that an amount of excitation energy absorbed by the fluorescent material 21 is limited.

Rapid decrease of the light emission intensity of the fluorescent material 21 closer to the condensing point is because the diameter (a spot diameter) of the converge beam L3 decreases excessively and the number of particles of the fluorescent material 21 excited by the converged beam L3 decreases.

As illustrated in the drawing, when there are characteristics that the light emission intensity at the condensing point (the distance 0.0 mm) has a minimum value and the light emission intensity close to the condensing point (for example, about the distance±0.5 mm) has a maximum value, a bright spot is formed at two positions in the direction of the optical axis AX in the vicinity of the condensing point. When a bright spot is formed at the two positions, the image quality of a stereoscopic image 22 which is to be originally drawn by forming a bright spot at the light condensing position decreases.

Therefore, the stereoscopic display device 1 according to the present embodiment improves the image quality of the stereoscopic image 22 by spatially dispersing the excitation energy of the converged beam L3 at the condensing point. Specific embodiments of the stereoscopic display device 1 will be described below.

### First Embodiment: Plurality of Axial Spots

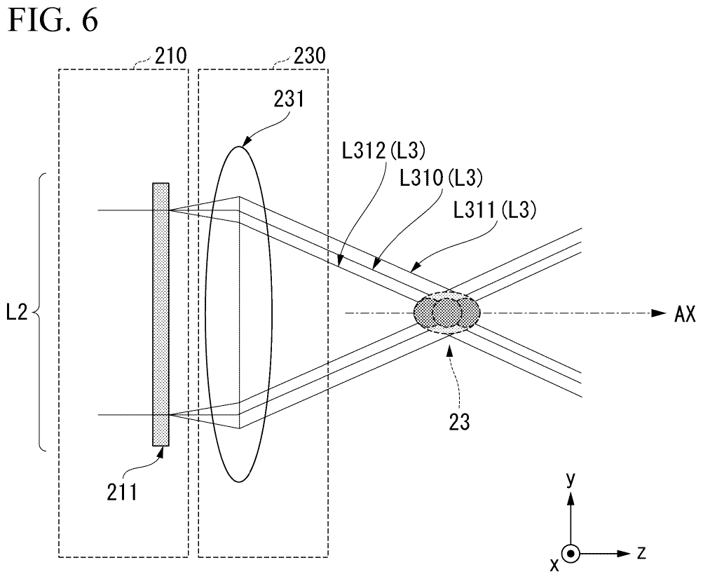

FIG. 6 is a diagram illustrating an example of an optical path of a converged beam L3 based on the divider 210 according to a first embodiment. In the present embodiment, the divider 210 includes, for example, a spatial phase modulator 211. The divider 210 divides a collimated beam L2 into a zeroth-order collimated beam L210, a +first-order collimated beam L211, and a −first-order collimated beam L212 using the spatial phase modulator 211. The divider 210 causes the divided zeroth-order collimated beam L210, the divided +first-order collimated beam L211, and the divided −first-order collimated beam L212 to be incident on the converger 230.

The converger 230 causes the zeroth-order collimated beam L210, the +first-order collimated beam L211, and the −first-order collimated beam L212 to converge on the condensing point of the light condensing position 23 using the converging lens 231. Here, the zeroth-order beam and the ±first-order beams caused to converge by the converging lens 231 are referred to as a zeroth-order converged beam L310, a +first-order converged beam L311, and a −first-order converged beam L312.

Here, at the light condensing position 23, a focal position of the zeroth-order converged beam L310 (zeroth-order beam) and focal positions of higher-order beams (the +first-order converged beam L311 and the −first-order converged beam L312) are distributed in the direction of the optical axis AX (the direction of the optical axis).

That is, the divider 210 distributes the focal position of the zeroth-order converged beam L310 (zeroth-order beam) and focal positions of the higher-order beams (the +first-order converged beam L311 and the −first-order converged beam L312) at positions apart from each other in the direction of the optical axis AX (the optical axis direction) at the light condensing position 23.

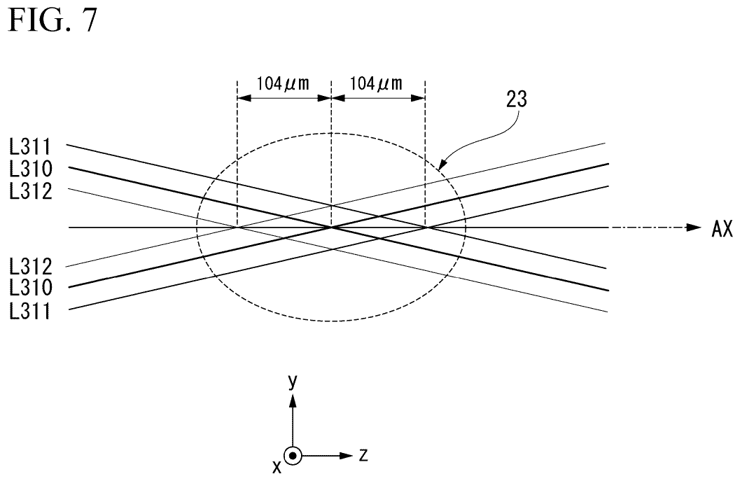

FIG. 7 is a diagram illustrating an example of an optical path in an enlarged view of the light condensing position 23 according to the present embodiment. At the light condensing position 23, a condensing point on which the +first-order converged beam L311 converges and a condensing point on which the −first-order converged beam L312 converges are distributed at positions apart from each other in the direction of the optical axis AX (for example, positions apart by ±104 μm) from the condensing point on which the zeroth-order converged beam L310 converges. That is, the divider 210 according to the present embodiment distributes the focal positions of the converged beams L3 at the positions apart from each other in the direction of the optical axis AX (the optical axis direction).

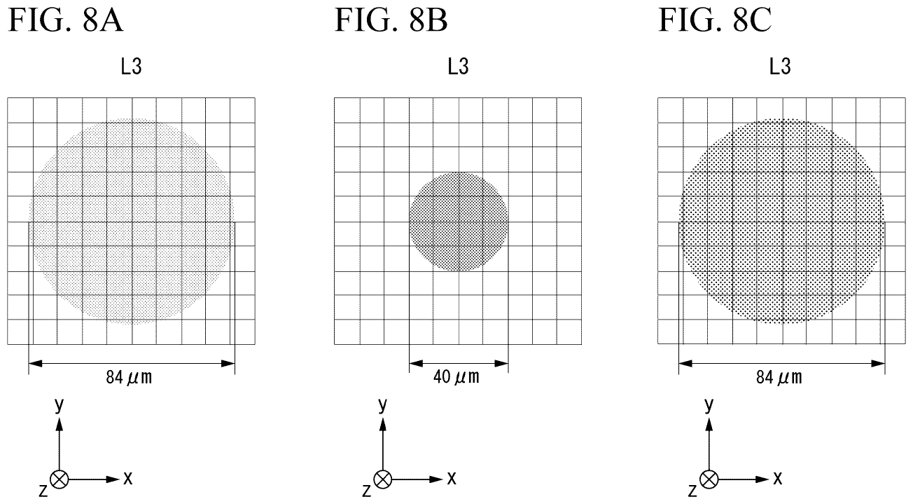

FIG. 8A-8C are a diagram illustrating an example of a cross-section of a converged beam L3 at the light condensing position 23 according to the present embodiment. FIG. 8A illustrates a diameter (for example, 84 μm) of the converged beam L3 at the condensing point (for example, a position apart by −104 μm) on which the −first-order converged beam L312 converges. FIG. 8B illustrates a diameter (for example, 40 μm) of the converged beam L3 at the condensing point on which the zeroth-order converged beam L310 converges. FIG. 8C illustrates a diameter (for example, 84 μm) of the converged beam L3 at the condensing point (for example, a position apart by +104 μm) on which the +first-order converged beam L311 converges.

This represents that the diameter of the converged beam L3 increases sufficiently at the light condensing position 23 and the energy density of the converged beam L3 per unit volume is less than that before the diameter increases.

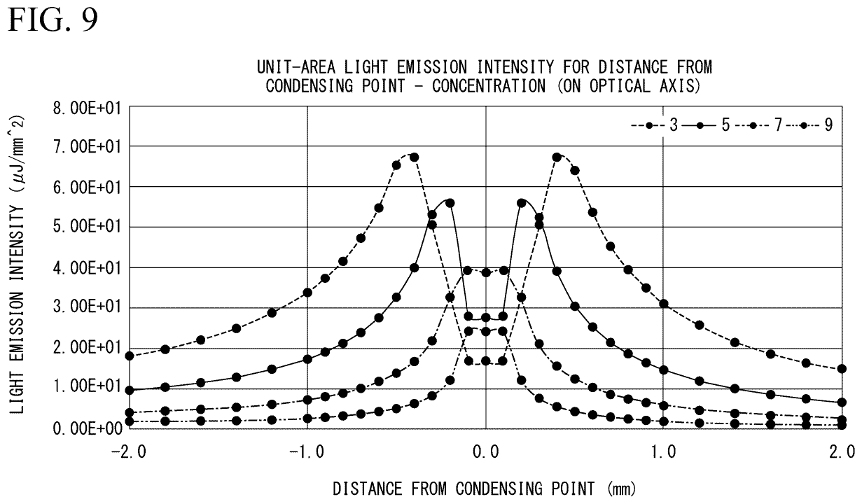

FIG. 9 is a diagram illustrating an example of a light emission intensity of the fluorescent material 21 according to the present embodiment. The horizontal axis and the vertical axis in the drawing are the same as those in FIG. 5.

As illustrated in the drawing, since the energy density of an excitation beam at the light condensing position 23 is decreased by the divider 210 according to the present embodiment, the decrease in light emission intensity in the range closer to the condensing point (for example, equal to or less than the distance±0.4 mm) is relaxed more than that in FIG. 5 (that is, in the related art).

Particularly, when the concentration of the fluorescent material 21 in the drawing space 2 is 7 [μg/mL] (Plot “7” in the example illustrated in the drawing), the decrease in light emission intensity in the range closer to the condensing point (for example, equal to or less than the distance±0.4 mm) is very small, and the phenomenon in which a bright spot is formed at two positions in the direction of the optical axis AX is curbed. That is, in the example of the present embodiment, when the concentration of the fluorescent material 21 in the drawing space 2 is 7 [μg/mL], it can be said that the image quality is optimized.

In this way, with the stereoscopic display device 1 including the divider 210 according to the present embodiment, it is possible to curb the phenomenon in which a bright spot is formed at two positions in the direction of the optical axis AX in the vicinity of the condensing point and to improve the image quality of the stereoscopic image 22.

### Example when Optimization is Performed Using Another Concentration

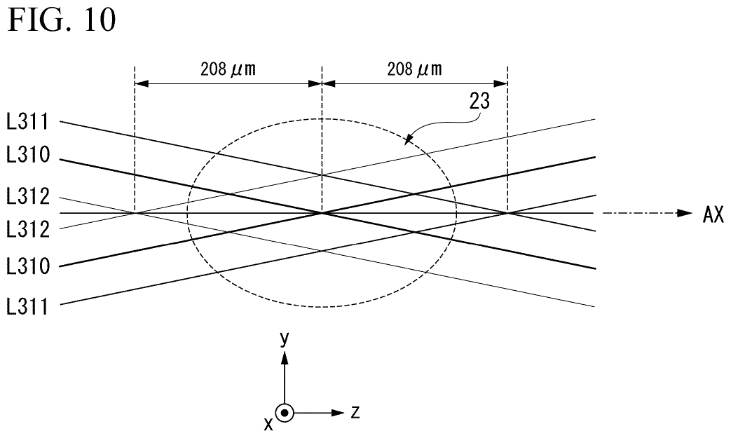

FIG. 10 is a diagram illustrating an example of an optical path in an enlarged view of the light condensing position 23 when optimization is performed using another concentration according to the present embodiment. In the present embodiment, when the concentration of the fluorescent material 21 in the drawing space 2 is 5 [μg/mL], the image quality is optimized.

More specifically, at the light condensing position 23, a condensing point on which the +first-order converged beam L311 converges and a condensing point on which the −first-order converged beam L312 converges are distributed at positions apart from each other in the direction of the optical axis AX (for example, positions apart by ±208 μm) from the condensing point on which the zeroth-order converged beam L310 converges. That is, the divider 210 according to the present embodiment distributes the focal positions of the converged beams L3 at the positions apart from each other in the direction of the optical axis AX (the optical axis direction).

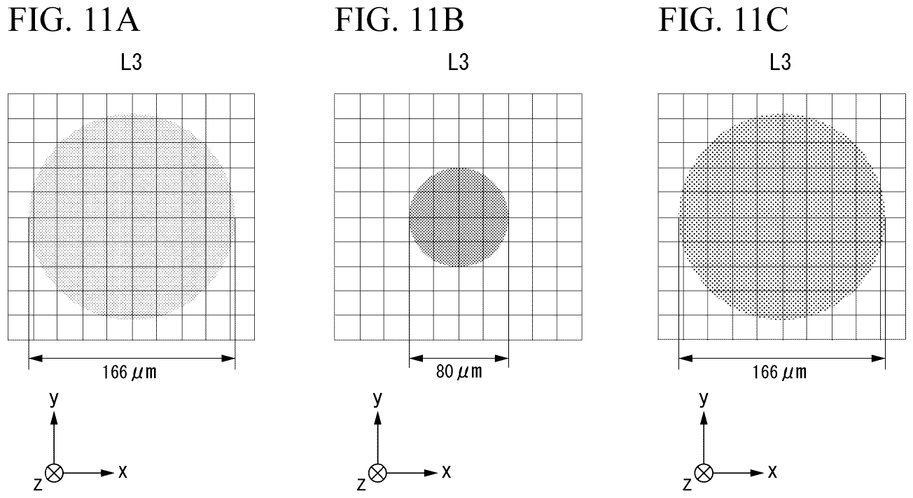

FIG. 11A-11C are a diagram illustrating an example of a cross-section of a converged beam L3 at the light condensing position 23 when optimization is performed using another concentration according to the present embodiment. FIG. 11A illustrates a diameter (for example, 166 μm) of the converged beam L3 at the condensing point (for example, a position apart by −208 μm) on which the −first-order converged beam L312 converges. FIG. 11B illustrates a diameter (for example, 80 μm) of the converged beam L3 at the condensing point on which the zeroth-order converged beam L310 converges. FIG. 11C illustrates a diameter (for example, 166 μm) of the converged beam L3 at the condensing point (for example, a position apart by +208 μm) on which the +first-order converged beam L311 converges.

This represents that the diameter of the converged beam L3 increases sufficiently at the light condensing position 23 and the energy density of the converged beam L3 per unit volume is less than that before the diameter increases.

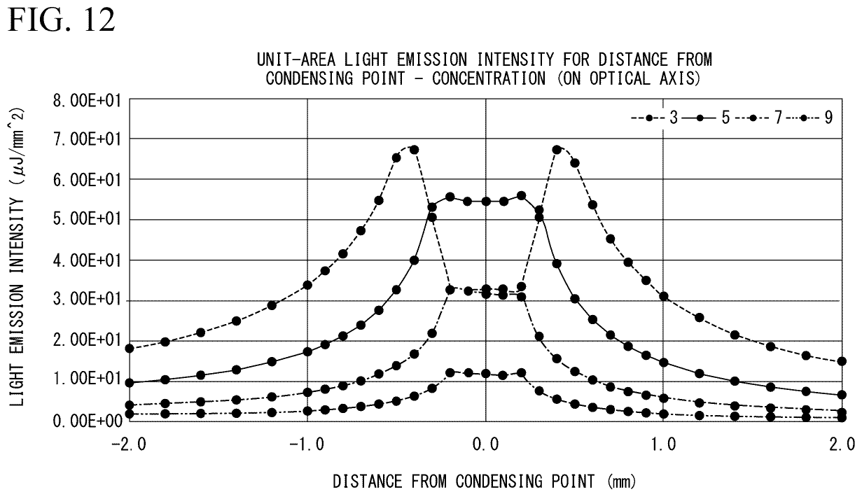

FIG. 12 is a diagram illustrating an example of a light emission intensity of the fluorescent material 21 according to the present embodiment. The horizontal axis and the vertical axis in the drawing are the same as those in FIGS. 5 and 9.

As illustrated in the drawing, since the energy density of an excitation beam at the light condensing position 23 is decreased by the divider 210 according to the present embodiment, the decrease in light emission intensity in the range closer to the condensing point (for example, equal to or less than the distance±0.4 mm) is relaxed more than that in FIG. 5 (that is, in the related art).

Particularly, when the concentration of the fluorescent material 21 in the drawing space 2 is 5 [μg/mL] (Plot “5” in the example illustrated in the drawing), the decrease in light emission intensity in the range closer to the condensing point (for example, equal to or less than the distance±0.4 mm) is very small, and the phenomenon in which a bright spot is formed at two positions in the direction of the optical axis AX is curbed. That is, in the example of the present embodiment, when the concentration of the fluorescent material 21 in the drawing space 2 is 5 [μg/mL], it can be said that the image quality is optimized.

In this way, with the stereoscopic display device 1 including the divider 210 according to the present embodiment, it is possible to curb the phenomenon in which a bright spot is formed at two positions in the direction of the optical axis AX in the vicinity of the condensing point and to improve the image quality of the stereoscopic image 22.

### Second Embodiment: Plurality of Parallel Spots

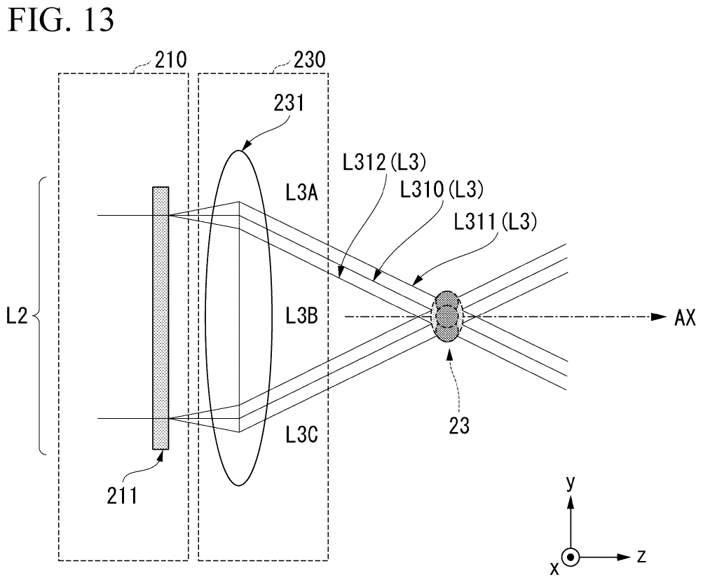

FIG. 13 is a diagram illustrating an example of an optical path of a converged beam L3 based on the divider 210 according to a second embodiment. In the present embodiment, the divider 210 includes, for example, a diffraction grating 212. The divider 210 divides a collimated beam L2 into a zeroth-order collimated beam L210, a +first-order collimated beam L211, and a −first-order collimated beam L212 using the diffraction grating 212. The divider 210 causes the divided zeroth-order collimated beam L210, the divided +first-order collimated beam L211, and the divided −first-order collimated beam L212 to be incident on the converger 230. The converger 230 causes the zeroth-order collimated beam L210, the +first-order collimated beam L211, and the −first-order collimated beam L212 to converge on the condensing point of the light condensing position 23 using the converging lens 231. Here, the zeroth-order beam and the ±first-order beams caused to converge by the converging lens 231 are referred to as a zeroth-order converged beam L310, a +first-order converged beam L311, and a −first-order converged beam L312.

Here, at the light condensing position 23, a focal position of the zeroth-order converged beam L310 (zeroth-order beam) and focal positions of the higher-order beams (the +first-order converged beam L311 and the −first-order converged beam L312) are distributed in the diameter direction of the converged beam L3 (the direction perpendicular to the optical axis AX).

That is, the divider 210 distributes the focal position of the zeroth-order converged beam L310 (zeroth-order beam) and focal positions of the higher-order beams (the +first-order converged beam L311 and the −first-order converged beam L312) at positions apart from each other in the diameter direction of the converged beam L3 at the light condensing position 23.

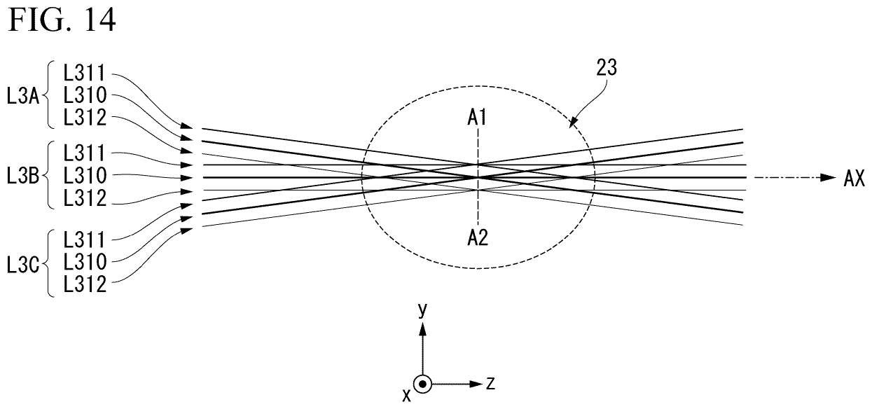

FIG. 14 is a diagram illustrating an example of an optical path in an enlarged view of the light condensing position 23 according to the present embodiment. At the light condensing position 23, a condensing point on which the +first-order converged beam L311 converges and a condensing point on which the −first-order converged beam L312 converges are distributed at positions apart from each other in the diameter direction of the converged beam L3 from the condensing point on which the zeroth-order converged beam L310 converges. In the example illustrated in the drawing, optical paths of a zeroth-order beam and higher-order beams of a light flux L3A, a zeroth-order beam and higher-order beams of a light flux L3B, and a zeroth-order beam and higher-order beams of a light flux L3C are schematically illustrated.

That is, the divider 210 according to the present embodiment distributes the focal positions of the converged beams L3 at the positions apart from each other in the diameter direction of the converged beams L3.

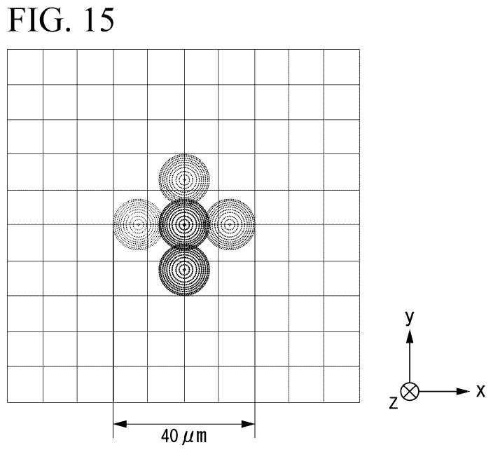

FIG. 15 is a diagram illustrating an example of a cross-section of a converged beam L3 at the light condensing position 23 according to the present embodiment. Since a laser beam Lis diffracted by the diffraction grating 212 of the divider 210, the converged beam L3 is distributed in a range of a predetermined diameter (for example, 40 μm) in the cross-section A1-A2 illustrated in the drawing.

This represents that the diameter of the converged beam L3 increases sufficiently at the light condensing position 23 and the energy density per unit volume is less than that before the diameter increases.

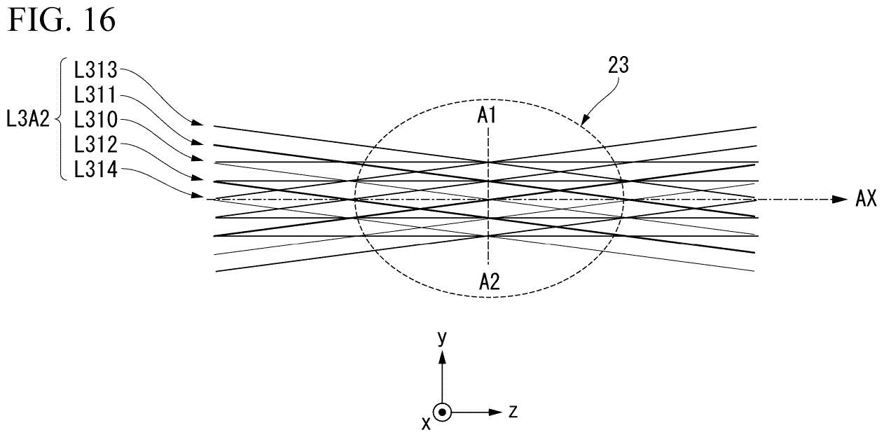

FIG. 16 is a diagram illustrating another example of an optical path in an enlarged view of the light condensing position 23 according to the present embodiment. In the drawing, for example, a light flux L3A2 includes ±second-order beams in addition to a zeroth-order beam and ±first-order beams. At the light condensing position 23, a condensing point on which the +first-order converged beam L311 converges, a condensing point on which the −first-order converged beam L312 converges, a condensing point on which the +second-order converged beam L313 converges, and a condensing point on which the −second-order converged beam L314 converges are distributed at positions apart from each other in the diameter direction of the converged beam L3 from the condensing point on which the zeroth-order converged beam L310 converges. In this way, the high-order beams may include the ±second-order beams or higher-order beams in addition to the ±first-order beams.

That is, the divider 210 according to the present embodiment distributes the focal positions of the converged beam L3 at positions apart from each other in the diameter direction of the converged beam L3.

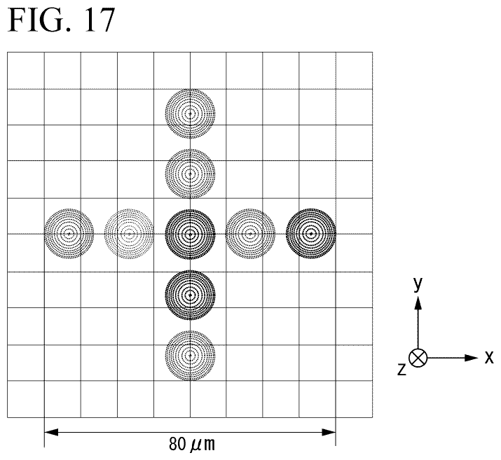

FIG. 17 is a diagram illustrating another example of a cross-section of a converged beam L3 at the light condensing position 23 according to the present embodiment. Since a laser beam L is diffracted by the diffraction grating 212 of the divider 210, the converged beam L3 includes the ±second-order beams in addition to the zeroth-order beam and the ±first-order beams and is distributed in a range of a predetermined diameter (for example, 80 μm) in the cross-section A1-A2 illustrated in the drawing.

This represents that the diameter of the converged beam L3 increases sufficiently at the light condensing position 23 and the energy density of the converged beam L3 per unit volume is less than that before the diameter increases.

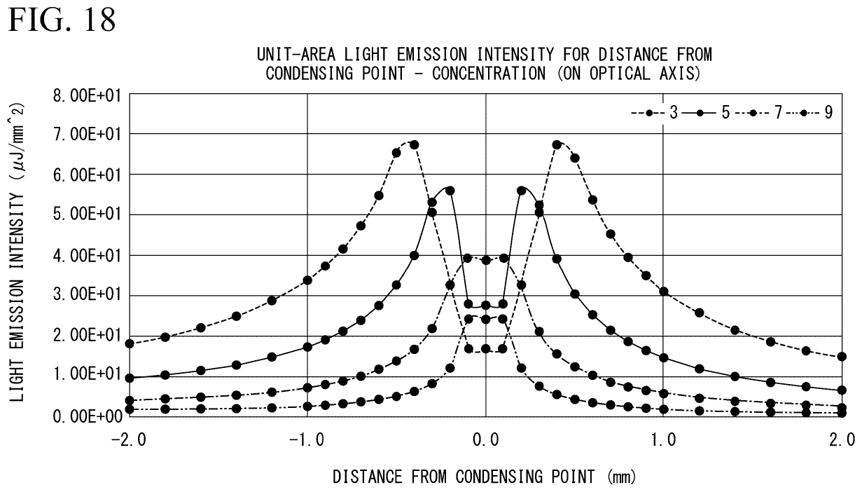

FIG. 18 is a diagram illustrating an example of the light emission intensity of the fluorescent material 21 according to the present embodiment. The horizontal axis and the vertical axis in the drawing are the same as those in FIGS. 5, 9, and 12.

As illustrated in the drawing, since the energy density of an excitation beam at the light condensing position 23 is decreased by the divider 210 according to the present embodiment, the decrease in light emission intensity in the range closer to the condensing point (for example, equal to or less than the distance±0.4 mm) is relaxed more than that in FIG. 5 (that is, in the related art).

Particularly, when the concentration of the fluorescent material 21 in the drawing space 2 is 7 [μg/mL] (Plot “7” in the example illustrated in the drawing), the decrease in light emission intensity in the range closer to the condensing point (for example, equal to or less than the distance±0.4 mm) is very small, and the phenomenon in which a bright spot is formed at two positions in the direction of the optical axis AX is curbed. That is, in the example of the present embodiment, when the concentration of the fluorescent material 21 in the drawing space 2 is 7 [μg/mL], it can be said that the image quality is optimized.

In this way, with the stereoscopic display device 1 including the divider 210 according to the present embodiment, it is possible to curb the phenomenon in which a bright spot is formed at two positions in the direction of the optical axis AX in the vicinity of the condensing point and to improve the image quality of the stereoscopic image 22.

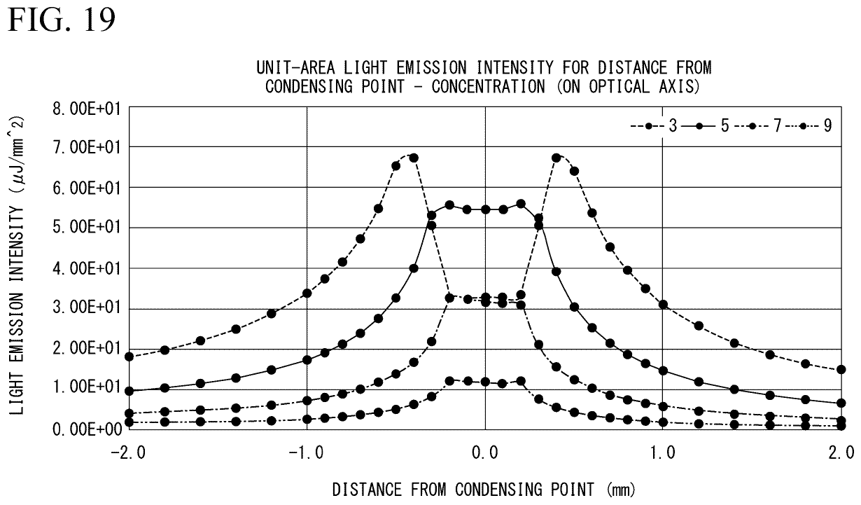

FIG. 19 is a diagram illustrating an example of a light emission intensity of the fluorescent material 21 according to the present embodiment. The horizontal axis and the vertical axis in the drawing are the same as those in FIGS. 5, 9, 12, and 18.

As illustrated in the drawing, since the energy density of an excitation beam at the light condensing position 23 is decreased by the divider 210 according to the present embodiment, the decrease in light emission intensity in the range closer to the condensing point (for example, equal to or less than the distance±0.4 mm) is relaxed more than that in FIG. 5 (that is, in the related art).

Particularly, when the concentration of the fluorescent material 21 in the drawing space 2 is 5 [μg/mL] (Plot “5” in the example illustrated in the drawing), the decrease in light emission intensity in the range closer to the condensing point (for example, equal to or less than the distance±0.4 mm) is very small, and the phenomenon in which a bright spot is formed at two positions in the direction of the optical axis AX is curbed. That is, in the example of the present embodiment, when the concentration of the fluorescent material 21 in the drawing space 2 is 5 [μg/mL], it can be said that the image quality is optimized.

In this way, with the stereoscopic display device 1 including the divider 210 according to the present embodiment, it is possible to curb the phenomenon in which a bright spot is formed at two positions in the direction of the optical axis AX in the vicinity of the condensing point and to improve the image quality of the stereoscopic image 22.

### Modified Example

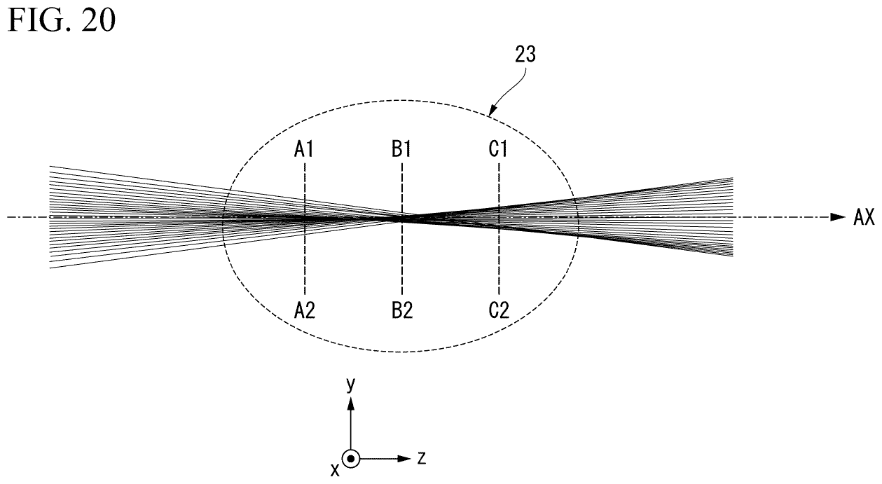

FIG. 20 is a diagram illustrating an example of an optical path in the vicinity of a light condensing position 23 according to a modified example of the present embodiment. In this modified example, an increase in diameter is performed using a spherical aberration instead of the diffraction grating 212. For example, when the converging lens 231 of the converger 230 is a spherical lens, the focal distance varies depending on positions in the diameter direction of the converging lens 231, that is, there is a spherical aberration. Accordingly, the collimated beam L2 incident on the converging lens 231 is emitted as a converged beam L3 having a focal distance varying depending on incident positions from the converger 230.

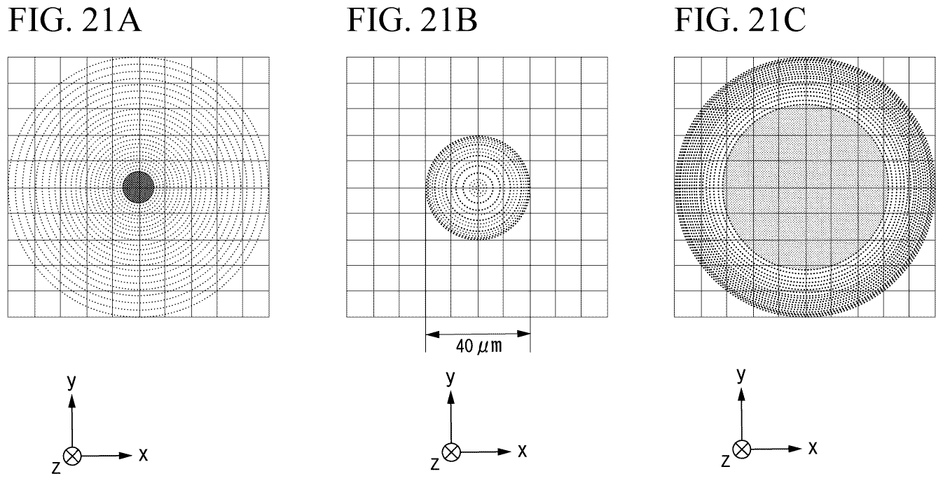

FIG. 21A-21C are a diagram illustrating an example of a cross-section of a converged beam L3 according to a modified example of the present embodiment. FIG. 21A illustrates a cross-section of a converged beam L3 in a cross-section A1-A2 illustrated in FIG. 20. FIG. 21B illustrates a cross-section of the converged beam L3 in a cross-section B1-B2 illustrated in FIG. 20. FIG. 21C illustrates a cross-section of the converged beam L3 in a cross-section C1-C2 illustrated in FIG. 20.

With the stereoscopic display device 1 having this configuration, it is possible to sufficiently increase the diameter of the converged beam L3 at the light condensing position 23. Accordingly, with the stereoscopic display device 1 according to the present modified example, it is possible to curb the phenomenon in which a bright spot is formed at two positions in the direction of the optical axis AX in the vicinity of the condensing point and to improve the image quality of the stereoscopic image 22.

When the divider 210 has a function of controlling a phase of a laser beam L such as the spatial phase modulator 211, the control unit 60 may perform feedforward control or feedback control of a phase of a converged beam L3 on the basis of a material of the fluorescent material 21 or a dispersion concentration in the drawing space 2, a bright spot forming state (for example, the number of bright spots on the optical axis AX) at the light condensing position 23, or the like.

As described above, with the stereoscopic display device 1 according to the present embodiment, it is possible to disperse the intensity of the converged beam L3 in the direction of the optical axis AX or the diameter direction of the converged beam L3. Accordingly, with the stereoscopic display device 1, it is possible to more relax the intensity of the converged beam L3 incident on the fluorescent material 21 on the optical axis AX in comparison with a case in which the intensity is not dispersed. As a result, with the stereoscopic display device 1, it is possible to curb a phenomenon in which a plurality of bright spots are formed on the optical axis AX because the intensity of the converged beam L3 incident on the fluorescent material 21 is excessively high. That is, with the stereoscopic display device 1 according to the present embodiment, it is possible to improve the image quality of the stereoscopic image 22.

While embodiments of the present invention have been described above, the present invention is not limited to the embodiments, and various modifications can be added thereto without departing from the gist of the present invention. The embodiments may be appropriately combined.

### REFERENCE SIGNS LIST

1 Stereoscopic display device
2 Drawing space
10 Light source unit
20 Irradiation unit
21 Fluorescent material
22 Stereoscopic image
23 Light condensing position
30 Storage unit
60 Control unit
110 Laser light source
120 Converter
210 Divider
230 Converger
240 Scanner
620 Intensity control unit

1. A stereoscopic display device comprising:
a laser light source configured to emit a laser beam;
a converter configured to convert the emitted laser beam to a collimated beam with a predetermined diameter;
a divider configured to divide the collimated beam into a zeroth-order beam and a higher-order beam equal to or higher than a first-order beam by changing a wavefront of the collimated beam;
a scanner configured to three-dimensionally scan a light condensing position of a converged beam by using a drawing space including a fluorescent material which is excited to spontaneously emit light with irradiation with a laser beam as a scan target range and changing optical axis directions in which converged beams including the zeroth-order beam and the higher-order beam are emitted and a focal distance at which the zeroth-order beam converges; and
an intensity control unit configured to control an intensity at the light condensing position on the basis of drawing data indicating a light emission intensity at each position in the drawing space.

2. The stereoscopic display device according to claim 1, wherein the divider is a spatial phase modulator and distributes a focal position of the zeroth-order beam and a focal position of the higher-order beam at positions apart in the optical axis directions at the light condensing position.

3. The stereoscopic display device according to claim 1, wherein the divider is a two-dimensional diffraction grating and distributes a focal position of the zeroth-order beam and a focal position of the higher-order beam at positions apart in diameter directions of the converged beams at the light condensing position.

4. A stereoscopic display method comprising:
emitting a laser beam;
converting the emitted laser beam to a collimated beam with a predetermined diameter;
dividing the collimated beam into a zeroth-order beam and a higher-order beam equal to or higher than a first-order beam by changing a wavefront of the collimated beam;
three-dimensionally scanning a light condensing position of a converged beam by using a drawing space including a fluorescent material which is excited to spontaneously emit light with irradiation with a laser beam as a scan target range and changing optical axis directions in which converged beams including the zeroth-order beam and the higher-order beam are emitted and a focal distance at which the zeroth-order beam converges; and
controlling an intensity at the light condensing position on the basis of drawing data indicating a light emission intensity at each position in the drawing space.
